(19) United States
(12) Patent Application Publication
(10) Pub. No.: US 2021/0270066 A1
(43) Pub. Date: Sep. 2, 2021

(54) LOCKING SYSTEM AND A METHODS FOR MANUFACTURING AND USING THE SAME

(71) Applicant: Refael Rubin, Netanya (IL)

(72) Inventor: Refael Rubin, Netanya (IL)

(21) Appl. No.: 17/257,658

(22) PCT Filed: Jul. 8, 2019
(86) PCT No.: PCT/IL2019/050754

§ 371 Date: Jan. 4, 2021

Related U.S. Application Data
(60) Provisional application No. 62/695,054, filed on Jul. 8, 2018.

(51) Int. Cl. E05C 19/18; E05C 19/06; E05C 17/52; E05B 65/00

(52) U.S. Cl. CPC E05C 19/182; E05C 19/06; E05Y 2900/20; E05B 65/0014; E05C 17/52

(57) ABSTRACT

The present subject matter provides a locking system configured to lock at least one furniture moving component, the locking system comprising: a strip configured to attach to a wall of a furniture and extend out of the furniture beyond the at least one furniture moving component; and a fastener configured to accommodate the strip, slide along the strip and fasten to the strip while clinging to the at least one furniture moving component, thereby locking the at least one furniture moving component. In addition, there is provided a method for manufacturing a fastener made of one piece of material, the method comprising: preparing a mold of the fastener; and inserting a casting material into the mold. Furthermore, there is provided a method for locking at least one furniture moving component of a furniture with the locking system of the present subject matter.

### CROSS-REFERENCE TO RELATED APPLICATION

This application claims priority to U.S. Provisional Patent Application No. 62/695,054, filed Jul. 8, 2018, the entire contents of which is incorporated herein by reference in its entirety.

### FIELD

The present subject matter relates to locking devices. More particularly, the present subject matter relates to locking devices for locking doors and drawers.

### BACKGROUND

Toddlers and young children tend to open doors and drawers of closets, cupboards, dressers, desks and the like—an action that can be in some occasions dangerous, if for example a drawer, or staff stored in a closet, falls down on the toddler. Therefore, there is a need to lock the doors and drawers in order to prevent them from being opened by toddlers.

### SUMMARY

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided a locking system configured to lock at least one furniture moving component, the locking system comprising: a strip configured to attach to a wall of a furniture and extend out of the furniture beyond the at least one furniture moving component; and a fastener configured to accommodate the strip, slide along the strip and fasten to the strip while clinging to the at least one furniture moving component, thereby locking the at least one furniture moving component.

According to one embodiment, the strip comprises a body comprising a plurality of slots, wherein the body is configured to extend out of the furniture beyond the at least one furniture moving component.

According to another embodiment, wherein the strip comprises an attaching element configured to attached to the wall of the furniture.

According to yet another embodiment, the fastener comprises a clinging element configured to cling to the at least one furniture moving component.

According to still another embodiment, the clinging element comprises an opening configured to accommodate the strip or the body of the strip.

According to a further embodiment, the fastener comprises a strip engaging element configured to engage with the strip or with a slot of the strip.

According to yet a further embodiment, the strip engaging element can be either in a locked state or an open state, wherein in the locked state the strip engaging element is configured to engage with the strip or with a slot of the strip, while in the open state, the strip engaging element is configured not to engage with the strip or with a slot of the strip.

According to still a further embodiment, the locked state is a default state.

According to an additional embodiment, the strip engaging element comprises two fastener teeth, each attached to a pressing element, wherein the fastener teeth are configured to engage with the strip or with a slot of the strip, and the pressing elements are configured to be pressed, thereby removing the fastener teeth from the strip or a slot of the strip.

According to yet an additional embodiment, the fastener teeth are adjacent to the clinging element, and the pressing elements are distant from the clinging element.

According to still an additional embodiment, the pressing elements are adjacent to the clinging element, and the fastener teeth are distant from the clinging element.

According to another embodiment, the fastener is made of one piece of material.

According to another aspect of the present subject matter, there is provided a method for manufacturing a fastener made of one piece of material, the method comprising: preparing a mold of the fastener; and inserting a casting material into the mold.

According to one embodiment, the casting material is plastic.

According to a further aspect of the present subject matter, there is provided a method for locking at least one furniture moving component of a furniture, the method comprising: attaching a strip to a wall of the furniture while letting a body of the strip to extend out of the furniture; accommodating the strip in a fastener; closing the at least one furniture moving component; sliding the fastener along the strip until the fastener clings to the at least one furniture moving component; and fastening the fastener to the strip.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms can be embodied in practice.

In the drawings:

FIG. 1 schematically illustrates, according to an exemplary embodiment, an upper view of a strip 12.

FIG. 2 schematically illustrates, according to an exemplary embodiment, a close up perspective view of an attaching element 126 of a strip 12.

FIG. 3 schematically illustrates, according to an exemplary embodiment, a close up perspective view of an attaching element 126 of a strip 12 and a sticker 1262.

FIG. 4 schematically illustrates, according to an exemplary embodiment, a close-up perspective view of an attaching element 126 of a strip 12, further comprising at least one hole 1266.

FIG. 5 schematically illustrates, according to an exemplary embodiment, a close-up perspective view of an attaching element 126 of a strip 12, further comprising at least one hole 1266, and a sticker.

FIG. 6 schematically illustrates, according to an exemplary embodiment, an upper view of a strip 12 further comprising at least one hole 1264 in the attaching element 126.

FIG. 7 schematically illustrates, according to an exemplary embodiment, an upper view of a strip 12 further comprising a foldable region 128.

FIG. 8 schematically illustrates, according to an exemplary embodiment, an upper view of a strip 12 further comprising a foldable region 128 and further comprising at least one hole 1264 in the attaching element 126.

FIG. 9 schematically illustrates, according to an exemplary embodiment, an upper view of a strip 12 further comprising an anchoring element 127.

FIG. 10 schematically illustrates, according to an exemplary embodiment, an upper perspective view of a strip 12 folded while an anchoring element 127 of the strip 12 is anchored in a slot 124.

FIG. 11 schematically illustrates, according to an exemplary embodiment, a side view of a strip 12 folded while an anchoring element 127 of the strip 12 is anchored in a slot 124.

FIG. 12 schematically illustrates, according to an exemplary embodiment, a side perspective view of a fastener 14.

FIG. 13 schematically illustrates, according to an exemplary embodiment, a bottom perspective view of a fastener 14.

FIGS. 14A-B schematically illustrate, according to an exemplary embodiment, a side view of a fastener 14 with a strip engaging element 146 in a locked state and an open state, respectively.

FIG. 15 schematically illustrates, according to an exemplary embodiment, a side perspective view a locking system 1, when a strip 12 is accommodated in an opening of a fastener 14.

FIG. 16 schematically illustrates, according to an exemplary embodiment, a side perspective view of a locking system 1, comprising a ring 16 in addition to a strip 12 and a fastener 14.

FIG. 17 schematically illustrates, according to one embodiment, a side perspective view of a locking system 1 attached to a wall 502 by adhering.

FIGS. 18A-B schematically illustrate, according to an exemplary embodiment, a side perspective view of a locking system 1 attached to a wall by screwing with screws.

FIG. 19 schematically illustrates, according to an exemplary embodiment, a side perspective view of a locking system 1 locking for at least one furniture moving component 504.

FIG. 20 schematically illustrates, according to an exemplary embodiment, a side perspective view of a locking system 1 locking at least one furniture moving component 504, while the strip 12 is folded and an anchoring element 127 of the strip 12 is anchored in a slot 124.

FIGS. 21A-D schematically illustrate, a front perspective view (FIG. 21A) and front views (FIG. 21B-D) of some exemplary embodiments of options for locking at least one furniture moving component 504 of a furniture 500 with a locking system 1.

FIG. 22 schematically illustrates, according to an exemplary embodiment, a side view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 23 schematically illustrates, according to an exemplary embodiment, an upper view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 24 schematically illustrates, according to an exemplary embodiment, an upper perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 25 schematically illustrates, according to an exemplary embodiment, a back perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 26 schematically illustrates, according to an exemplary embodiment, a front perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 27 schematically illustrates, according to an exemplary embodiment, a close-up perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 28 schematically illustrates, according to an exemplary embodiment, a side view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 29 schematically illustrates, according to an exemplary embodiment, an upper view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 30 schematically illustrates, according to an exemplary embodiment, an upper perspective view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 31 schematically illustrates, according to an exemplary embodiment, a perspective side cross-section view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 32 schematically illustrates, according to an exemplary embodiment, a perspective front cross-section view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 33 schematically illustrates, according to an exemplary embodiment, a bottom perspective view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 34 schematically illustrates, according to an exemplary embodiment, an upper view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 35 schematically illustrates, according to an exemplary embodiment, a perspective side cross-section view of a body 122 of a strip 12 accommodated in an opening 144 of a fastener 14, when fastener teeth 1462 of the fastener 14 are distant from a clinging element 142 of the fastener 14 and pressing elements 1464 of the fastener 14 are adjacent to the clinging element 142 of the fastener 14.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

The present subject matter provides a locking system 1 configured to lock doors, drawers and the like of furniture like closets, cupboards, dressers, desks and the like. For the sake of simplicity only, the door and drawer of a furniture is designated herein as “furniture moving component”. More particularly, the locking system 1 is configured to prevent opening of furniture moving components by toddlers, while allowing easy unlocking of the locking system 1 by older children and adults. Some prior art furniture moving components are manufactured with a locking mechanism installed in them. Alternatively, a locking mechanism can be installed in a furniture moving component at a later stage, while for example drilling a hole or cutting a piece of the furniture moving component in order to facilitate the installation of the locking mechanism. The locking system 1 of the present subject matter is advantageous over prior art locking mechanisms for furniture moving components in the sense that it allows easy locking of the furniture moving components without using locking mechanisms that are installed during manufacture of the furniture moving components or installed in them at a later stage.

According to one embodiment, the locking system 1 comprises a strip 12 and a fastener 14.

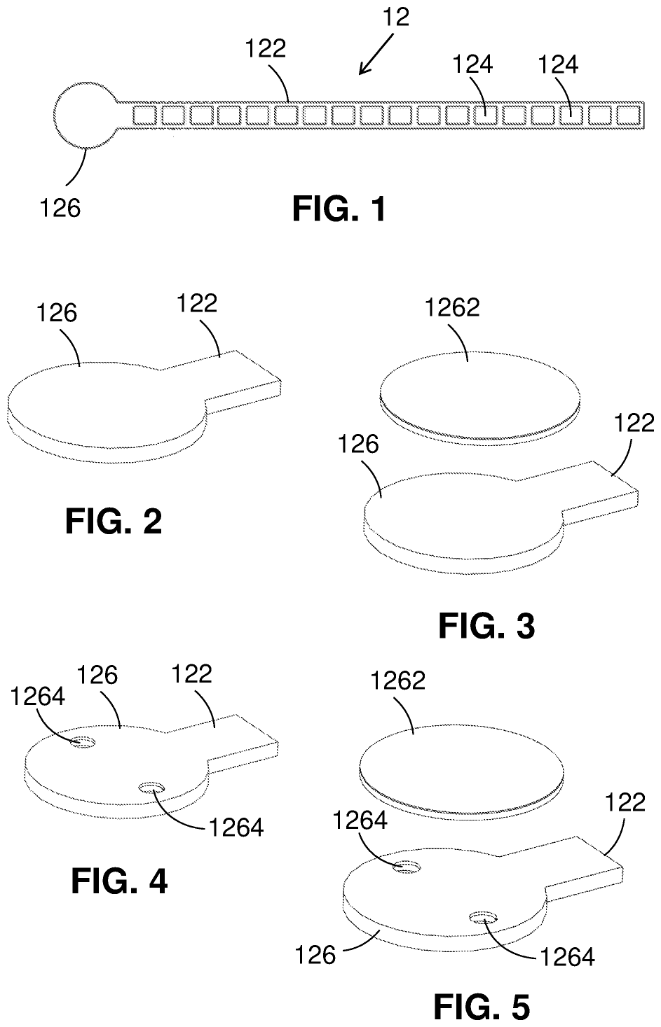

FIG. 1 schematically illustrates, according to an exemplary embodiment, an upper view of a strip 12. According to one embodiment, the strip 12 is flexible. According to another embodiment, the strip 12 is resistant to breakage or tearing, at least by a toddler. Thus, the strip 12 is made of any material known in the art that is flexible in one hand and resistant to breakage or tearing, at least by a toddler, on the other hand. Exemplary materials of which the strip 12 can be made of are flexible metal, for example tin, flexible plastic and the like. The strip 12 comprises a body 122, the body 122 comprising a plurality of slots 124 arranged along the body 122. The strip 12 further comprises an attaching element 126 at one end of the body 122. The attaching element 126 is configured to attach to a wall. The term “wall” as mentioned herein refers to a wall of a furniture—for example a closet, a cupboard, a dresser, a desk and the like.

FIG. 2 schematically illustrates, according to an exemplary embodiment, a close up perspective view of an attaching element 126 of a strip 12. According to one embodiment, the attaching element 126 is wider than the body 122 as can be seen in FIGS. 1 and 2. However, according to some other embodiments, the attaching element 126 can have the same width as the body 122 or a smaller width than the body 122. Preferably, the attaching element 126 is wide enough to be in a strong contact with a wall when attached to the wall by adhering or gluing for example. Furthermore, the attaching element 126 can have any shape known in the art, for example, as illustrated in FIGS. 1 and 2, the attaching element 126 can be circular. It should be noted though that this embodiment of circular attaching element 126 is only exemplary and not considered as limiting the scope of the present subject matter. The attaching element 126 can be attached to a wall by gluing or adhering while using a glue or any other adhering material known in the art.

FIG. 3 schematically illustrates, according to an exemplary embodiment, a close up perspective view of an attaching element 126 of a strip 12 and a sticker 1262. According to one embodiment, the sticker 1262 can be attached to the attaching element 126 and covered with a foil (not seen) made for example of paper. The foil is configured to be pilled-off the sticker 1262 and allow adherence of the sticker 1262 to a wall. According to another embodiment, the sticker 1262 is a double-side sticker and it is separated from the strip 12, as can be seen in FIG. 3. Both sides of the double-sided sticker 1262 can be covered with a foil made for example of paper. The foils are configured to be pilled-off the double-sided sticker 1262, and then one side of the sticker 1262 is configured to adhere to the attaching element 126, and the other side of the double-sided sticker 1262 is configured to adhere to a wall. According to yet another embodiment, the sticker 1262 is one-sided, namely only one side of the sticker 1262 is covered with an adhering material and a foil over the adhering material. Thus, the side of the sticker 1262 that is not covered with an adhering material is configured to adhere to the attaching element 126, for example by using an adhering material like glue; while the side of the sticker 1262 that is covered with an adhering material and a foil is configured to adhere to a wall after the foil is pilled-off. According to still another embodiment, the side of the sticker 1262 that is covered with an adhering material can be adhered to the attaching element 126 after the foil is pilled-off, and the side of the sticker 126 that is not covered with an adhering material is configured to adhere to a wall by using an adhering material, like glue.

FIG. 4 schematically illustrates, according to an exemplary embodiment, a close-up perspective view of an attaching element 126 of a strip 12, further comprising at least one hole 1264. According one embodiment, the attaching element 126 is configured to attach to a wall by screwing the attaching element 126 to the wall with at least one screw. Accordingly, the attaching element 126 comprises at least one hole 1264 configured to allow a screw to be screwed through it in order to facilitate screwing of the attaching element 126 with screws. In other words, a screw is inserted into a hole 1264 and then screwed into a wall in order to attach the attaching element 126 to the wall. Any number of holes 1264 in the attaching element 126 is under the scope of the present subject matter, for example, as illustrated in FIG. 4, the attaching element 126 comprises two holes 1264.

FIG. 5 schematically illustrates, according to an exemplary embodiment, a close-up perspective view of an attaching element 126 of a strip 12, further comprising at least one hole 1264, and a sticker 1262. All the embodiments concerning the holes 1264 described in FIG. 4, and all the embodiments concerning the sticker 1262 described in FIG. 3, pertain to the embodiment illustrated in FIG. 5. According to an additional embodiment, the sticker 1262 is configured to be adhered to an exposed surface of the attaching element 126 that is attached to a wall by screwing at least one screw through the at least one hole 1264. According to yet an additional embodiment, the sticker 1262 is configured to cover the at least one hole 1264 and the at least one screw that is in the at least one hole 1264, for example for a purpose of decoration and aesthetic appearance.

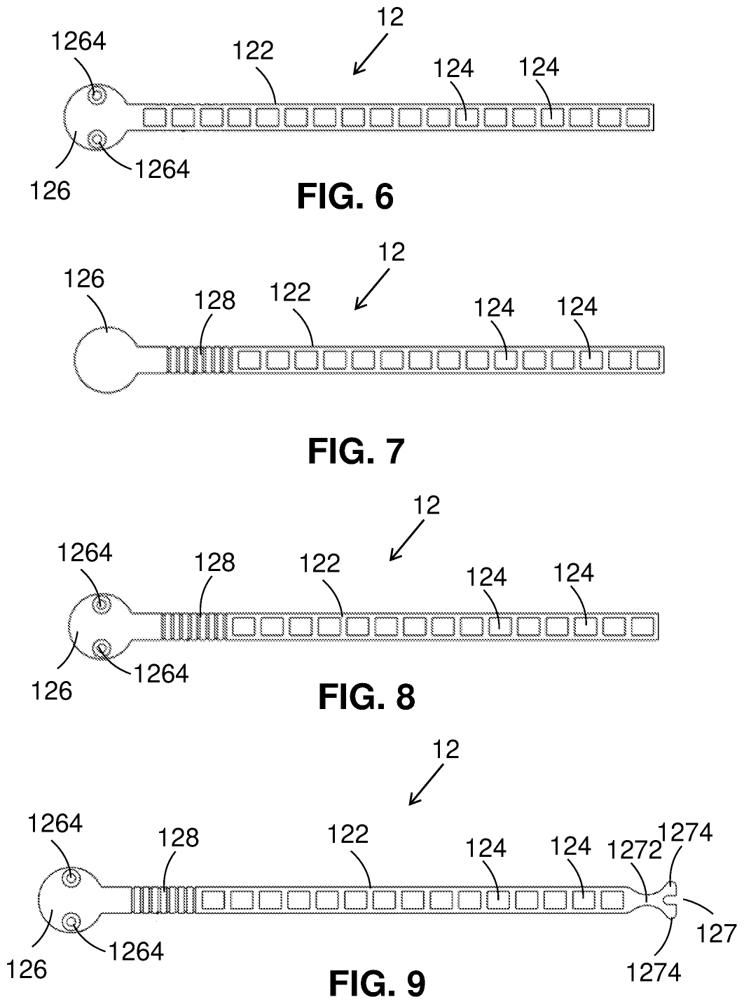

FIG. 6 schematically illustrates, according to an exemplary embodiment, an upper view of a strip 12 further comprising at least one hole 1264 in the attaching element 126. All the embodiments concerning the holes 1264 described in FIG. 4, pertain to the embodiment illustrated in FIG. 6.

FIG. 7 schematically illustrates, according to an exemplary embodiment, an upper view of a strip 12 further comprising a foldable region 128. The foldable region 128 is positioned between the plurality of slots 124 in the body 122 and the attaching element 126, and is configured to be folded. This embodiment facilitates adjustment of the strip 12 to a wall or a to which the attaching element 126 of the strip 12 is attached. According to one embodiment, the flexibility of the folding region 128 is higher than the flexibility of the body 122 of the strip 12. When the attaching element 126 is attached to a wall, the strip 12 adjusts to the contour of the wall and/or the furniture moving component by folding accordingly the foldable region 128.

FIG. 8 schematically illustrates, according to an exemplary embodiment, an upper view of a strip 12 further comprising a foldable region 128 and further comprising at least one hole 1264 in the attaching element 126. All the embodiments concerning the foldable region 128 described in FIG. 7 and the holes 1264 described in FIG. 4, pertain to the embodiment illustrated in FIG. 8.

FIG. 9 schematically illustrates, according to an exemplary embodiment, an upper view of a strip 12 further comprising an anchoring element 127. The anchoring element 127 is at an opposite end of the strip 12 relative to the attaching element 126. The anchoring element 127 is configured to engage with a slot 124 of the body 122 and anchor there. FIG. 9 illustrates a strip 12 comprising, in addition to the anchoring element 127, at least one hole 1264 in the attaching element 126 and a foldable region 128. However, also other embodiments of the strip 12 described above that do not comprise at least one hole 1264, a sticker 1262, a foldable region 128 and any combination thereof, can comprise the anchoring element 127 (not shown).

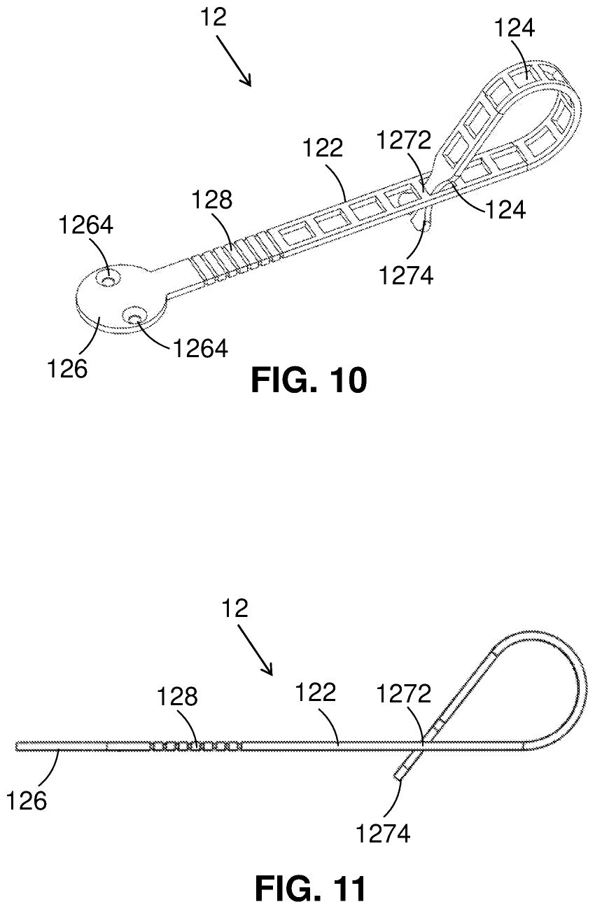

FIG. 10 schematically illustrates, according to an exemplary embodiment, an upper perspective view of a strip 12 folded while an anchoring element 127 of the strip 12 is anchored in a slot 124.

FIG. 11 schematically illustrates, according to an exemplary embodiment, a side view of a strip 12 folded while an anchoring element 127 of the strip 12 is anchored in a slot 124.

According to the embodiments illustrated in FIGS. 10-11, the flexible body 122 of the strip 12 is bent in a manner that allows engagement of the anchoring element 127 with a slot 124 of the body 122. The anchoring element 127 is configured to engage with a slot 124 and anchor to the slot 124. Thus, any shape of the anchoring element 127 that allows engagement of the anchoring element 127 with a slot 124 and anchor to the slot 124, is under the scope of the present subject matter. According to the exemplary embodiment illustrated in FIGS. 10-11, the anchoring element 127 comprises a neck 1272 attached to the body 122 and at least one tooth 1274, for example two teeth 1274, attached to the neck 1272. The width of the neck 1272 is smaller than a width of a slot 124, as can be seen in FIG. 10. Therefore, the neck 1272 is configured to be inside the slot 124. On the other hand, the at least one tooth 1274 altogether is wider than the slot 124 and flexible. Therefore, the at least one tooth 1274 is configured to path through a slot 124 while folded, and then when the at least one tooth 1274 becomes straight back, as can be seen in FIGS. 10-11, the at least one tooth 1274 gets stuck in the slot 124. Advantages of this embodiment, will be described hereinafter.

As mentioned above, in addition to the strip 12, the locking system 1 comprises a fastener 14.

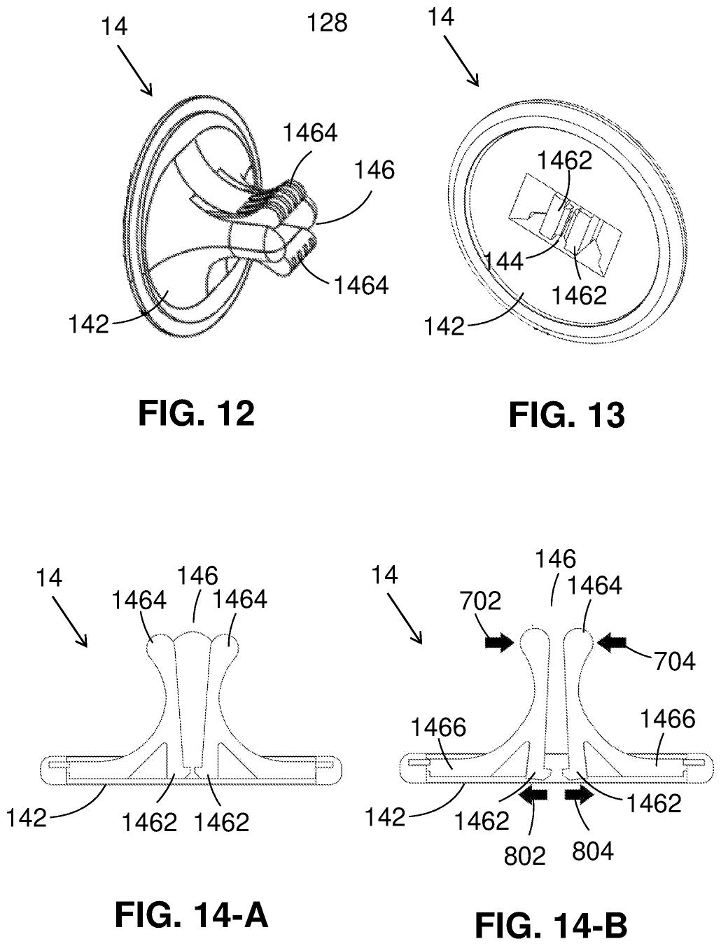

FIG. 12 schematically illustrates, according to an exemplary embodiment, a side perspective view of a fastener 14.

FIG. 13 schematically illustrates, according to an exemplary embodiment, a bottom perspective view of a fastener 14.

According to one embodiment, the fastener 14 is configured to slide along the strip 12, get fastened to the strip 12, and while fastened to the strip 12 lock a furniture moving component, or in other words prevent opening of a furniture moving component, particularly by a toddler.

According to one embodiment, the fastener 14 comprises a clinging element 142 configured to cling to an at least one furniture moving component. The clinging element 142 is substantially flat and wide and can have any shape known in the art. In FIGS. 12-13 the clinging element 142 is circular. However, the embodiment of the clinging element 142 illustrated in FIGS. 12-13 should not be considered as limiting the scope of the present subject matter. As can be seen in FIG. 13, the clinging element 142 comprises an opening 144 configured to accommodate a body 122 of a strip 12. The fastener 14 further comprises a strip engaging element 146 configured to engage with the strip 12 when the strip 12 is accommodated in an opening 144 in the clinging element 142 of the fastener 14. In an embodiment of a strip comprising a plurality of slots 124, the strip engaging element 146 is configured to engage with a slot 124 of the strip 12 when the strip 12 is accommodated in an opening 144 in the clinging element 142 of the fastener 14. Any mechanism known in the art for engaging with the strip 12, and more particularly with a slot 124 of the strip 12 is under the scope of the present subject matter. FIGS. 12-13 illustrate an exemplary mechanism of the strip engaging element 146 for engaging with a strip 12, and more particularly with a slot 124 of the strip 12.

FIGS. 14A-B schematically illustrate, according to an exemplary embodiment, a side view of a fastener 14 with a strip engaging element 146 in a locked state and an open state, respectively. In the locked state, the strip engaging element 146 is configured to engage with the strip 12 or with a slot 124 of the strip 12, while in the open state, the strip engaging element 146 is configured not to engage with the strip 12 or with a slot 124 of the strip 12. According to one embodiment, the strip engaging element 146 of the fastener 14 comprises two fastener teeth 1462, each attached to a pressing element 1464. According to another embodiment, the strip engaging element 146 further comprises an elastic element 1466 attached to each pressing element 1464. According to yet another embodiment, at least part of the strip engaging element 146 is elastic.

According to one embodiment, the strip engaging element 146 can be in a locked state, illustrated in FIG. 14A, or in an open state illustrated in FIG. 14B. According to another embodiment, the locked state of the strip engaging element 146 is a default state. The default state can be achieved, for example, by the elastic elements 1466 that are attached to the pressing elements 1464.

In the locked state, illustrated in FIG. 14A, the fastener teeth 1462 are close one to the other, while the pressing elements 1464 are positioned apart one from the other. The fastener teeth 1462 that are close one to the other block the opening 144 of the fastener 14, thereby do not allow accommodation of a strip 12 in the opening 144. In the open state, illustrated in FIG. 14B, the fastener teeth 1462 are apart one from the other, while the pressing elements 1464 are close one to the other. This can be achieved, for example, by pressing the pressing elements 1464 one toward the other, as indicated with arrows 702 and 704 in FIG. 14B. As a result, the fastener teeth 1462 move apart one from the other, as indicated with arrows 802 and 804 in FIG. 14B. Since the fastener teeth 1462 are apart one from the other in the open state, they leave the opening 144 of the fastener 14 open, thereby allowing accommodation of a strip 12 in the opening 144. In order to bring the strip engaging element 146 back to the default locked state, the pressing elements 1464 are released. As a result, the pressing elements 1464 return back to the locked state, as illustrated in FIG. 14A, by moving apart one from the other, while the fastener teeth 1462 move one toward the other.

It should be noted that the scope of the present subject matter is not limited to a strip 12 comprising a plurality of slots 124 and a fastener 14 configured to engage with a slot 124 as described in FIGS. 12, 13 and 14A-B. A more general scope of the present subject matter is to provide a strip 12 and a fastener 14 configured to slide along the strip 12, fasten to the strip 12 and get locked with the strip 12 by any mechanism known in the art. For example, the strip 12 can comprise any element known in the art that allows fastening of the fastener 14 to the strip 12, for example slots 124, as described herein, teeth, recesses and the like; and the fastener 14 can comprise any element known in the art that allows fastening of the fastener 14 to the strip 12, for example a strip engaging element 146, as described herein, a tooth engaging element, a recess engaging element, and the like.

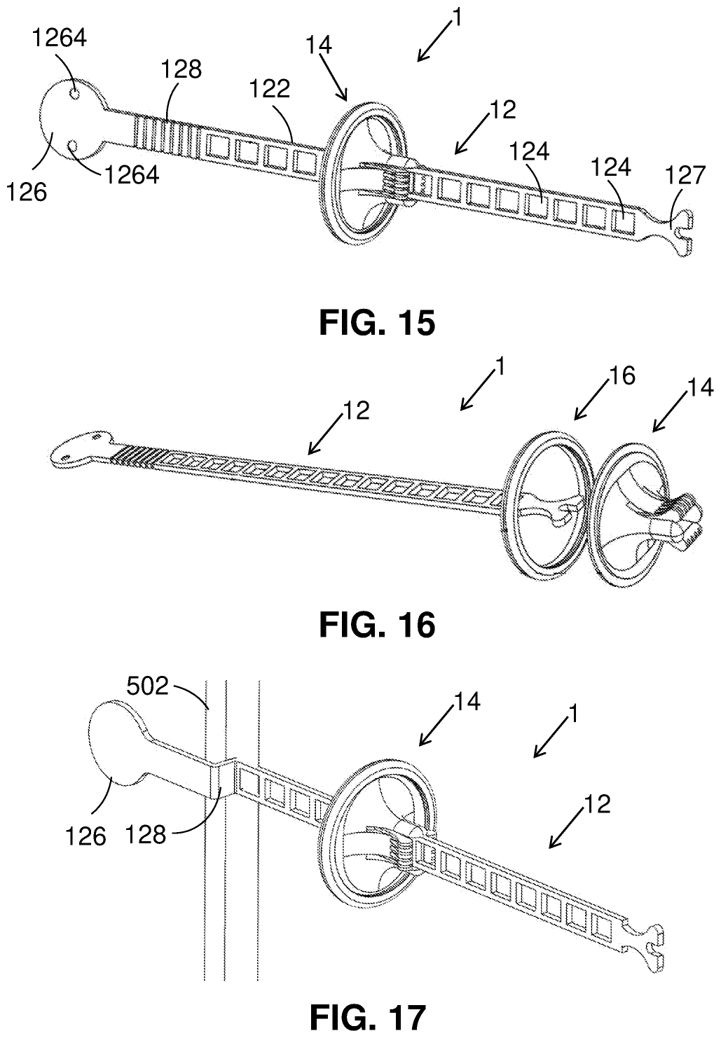

FIG. 15 schematically illustrates, according to an exemplary embodiment, a side perspective view a locking system 1, when a strip 12 is accommodated in an opening 144 of a fastener 14. The strip 12 is accommodated in the opening 144 of the fastener 14 that is in an open state, for example by pressing the pressing elements 1464 and thereby moving the fastener teeth 1462 apart, and inserting the strip 12 into the un-blocked opening 144. As long as the pressing elements 1464 are pressed, and the strip engaging element 146 of the fastener 14 is in the open state, the fastener 14 can slide along the strip 12. When the pressing elements 1464 are released the fastener teeth 1462 move one toward the other and engage with a slot 124 of the strip 12. This locks the fastener 14 in place on the strip 12.

FIG. 16 schematically illustrates, according to an exemplary embodiment, a side perspective view of a locking system 1, comprising a ring 16 in addition to a strip 12 and a fastener 14. According to one embodiment, the locking system 1 can further comprise a ring 16, configured to be positioned between a fastener 14 and a furniture moving component during locking of the furniture moving component with the locking system 1. In addition, the ring 16 is configured to provide mechanical strength to the clinging element 142 while locking a furniture moving component. According to a further embodiment, the ring 16 is configured to protect the furniture moving component 504 against scratches that can be caused by the clinking element 142 when it is locking the furniture moving component 504. According to yet a further embodiment, the ring is configured to prevent catching of finger of a toddler by the clinging element 142 when locking a furniture moving element. According to an additional embodiment, the ring 16 is made of a soft material, like plastic. Preferably, the ring 16 is made of silicon.

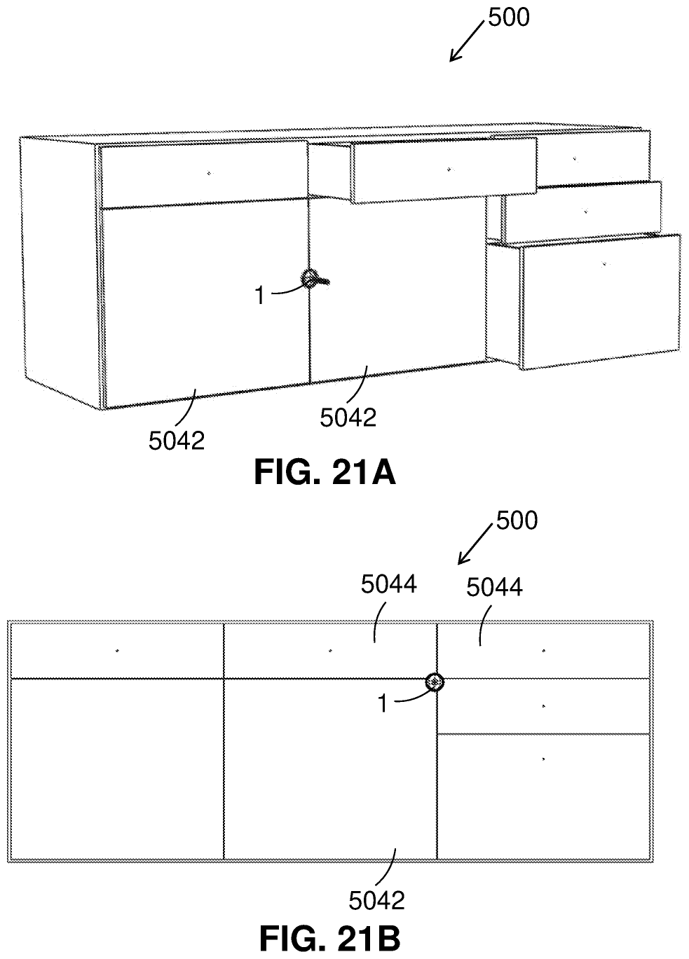

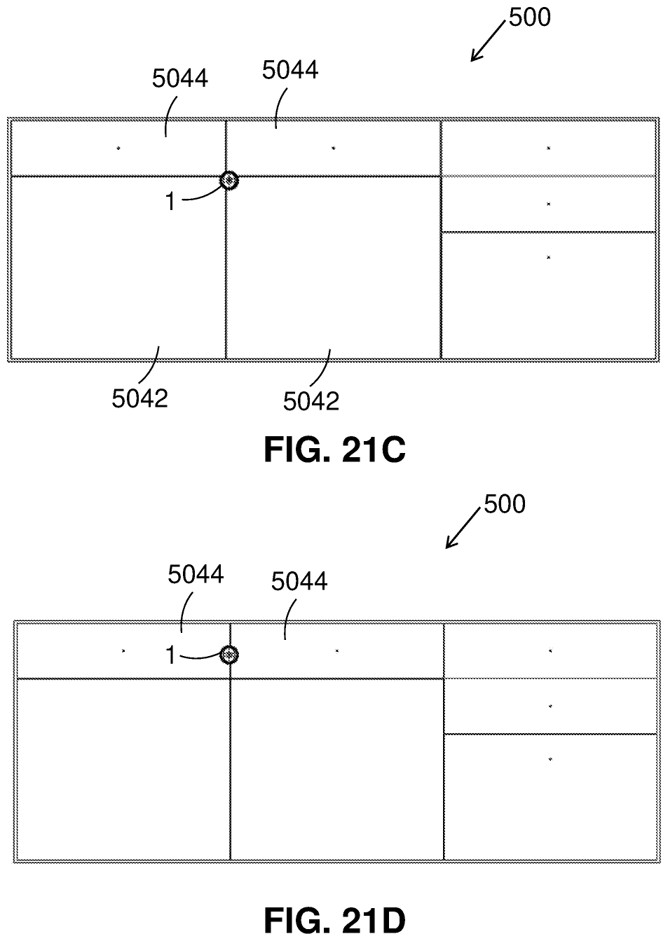

According to one embodiment, the locking system 1 comprises a plurality of rings 16 in different sizes. This embodiment allows increasing of a surface area that is in contact with the furniture moving component 504, for example by using a large ring, thus increasing the strength of locking of the furniture moving component 504. Furthermore, a large ring 16 can allow locking of a plurality of furniture locking elements 142, as can be seen, for example in FIGS. 21A-D.

FIG. 17 schematically illustrates, according to one embodiment, a side perspective view of a locking system 1 attached to a wall 502 by adhering. According to one embodiment, the attaching element 126 of a strip 12 is attached to a wall 502 by adhering by any of the embodiments of adhering or gluing described above. According to another embodiment, during the attaching of the strip 12 to the wall 502, the strip 12 can be accommodated in an opening 144 of a fastener 14. According to yet another embodiment, the strip 12 can be positioned inside a ring 16, when the ring 16 is positioned between the wall 502 and the fastener 16. The strip 12 is attached to the wall 502 is such a manner that leaves the body 122 of the strip 12 extending outwards of a frontage of a furniture, when a furniture moving component is open. According to another embodiment, there are cases where there is a need to fit the strip 12 to the shape of the wall 502, or to the shape of the furniture moving component, or to the shape of the wall 5012 and to the shape of the furniture moving component. In these cases, the flexible region 128 of the strip 12 is configured to bend and adapt to the shape of the wall, or to the shape of the furniture moving component, or to the shape of the wall and to the shape of the furniture moving component, as can be seen in FIG. 17.

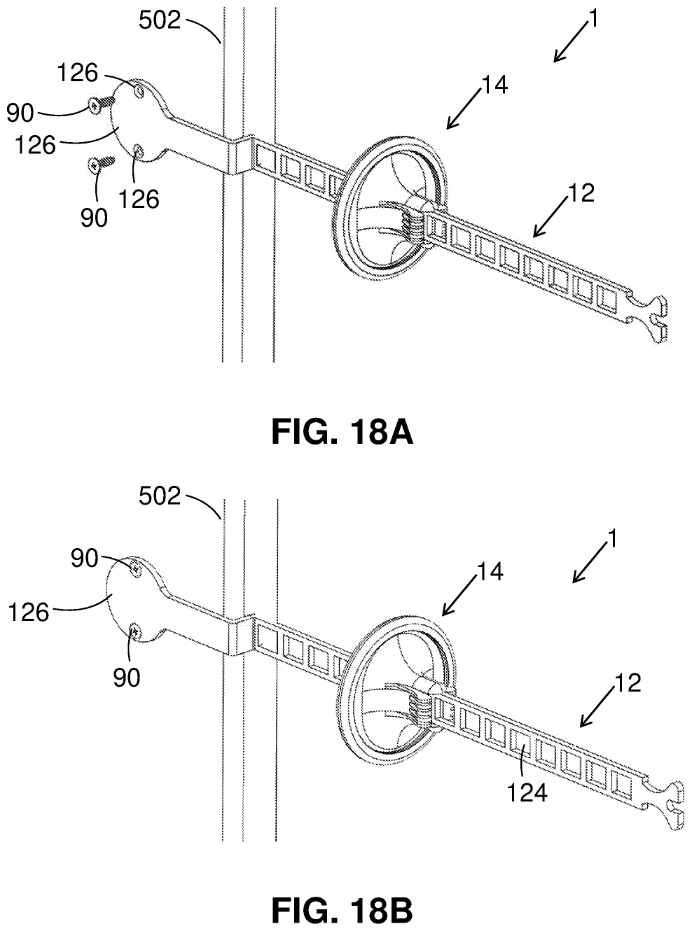

FIGS. 18A-B schematically illustrate, according to an exemplary embodiment, a side perspective view of a locking system 1 attached to a wall 502 by screwing with screws 90. All the embodiments illustrated in FIGS. 18A-B are similar to the embodiment illustrated in FIG. 17, except that the attaching element 126 of the strip 12 is attached to the wall 502 by screwing with screws 90. FIG. 18A shows an attaching element 126 comprising two holes 1264 configured to accommodate screws 90, and two corresponding screws 90 aside the attaching element 126. FIG. 18B illustrates the attaching element 126 attached to the wall 502 by the screws 90 that are screwed through the holes 1264 into the wall 502.

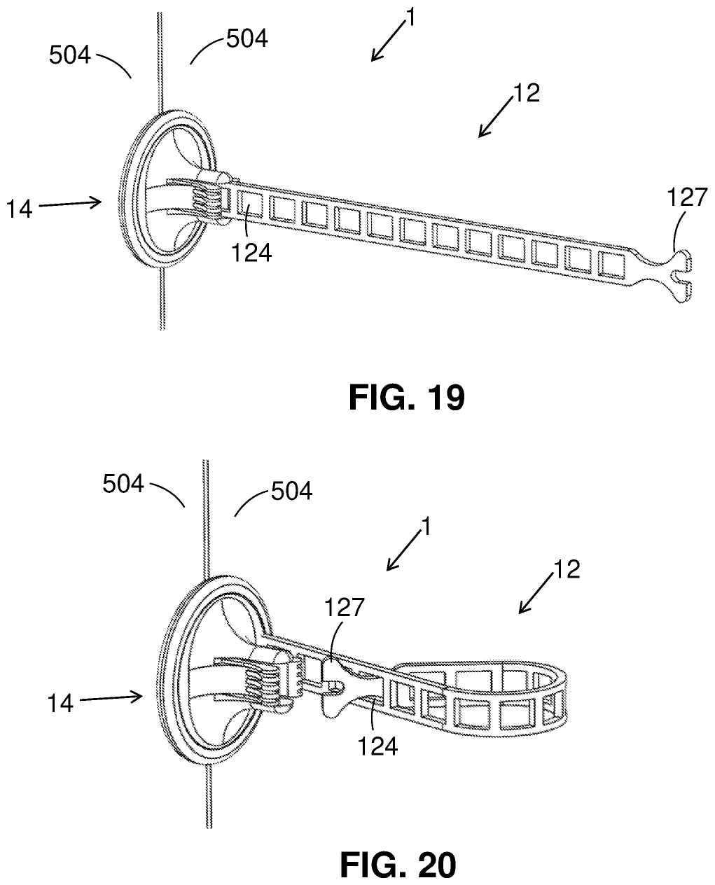

FIG. 19 schematically illustrates, according to an exemplary embodiment, a side perspective view of a locking system 1 locking at least one furniture moving component 504. After the locking system 1 is attached to a wall 502, as described in FIGS. 17 and 18A-B, at least one furniture moving component 504 that is adjacent to the wall 502 to which the locking system 1 is attached, is closed, while leaving the strip 12 of the locking system 1 to extend beyond a frontage of the at least one furniture moving component 504. Then, the fastener 14 slides along the strip 12 towards the at least one furniture moving component 504, until the clinging element 142 engages with the at least one furniture moving component 504. At this stage, the fastener 14 is engaged with a slot 124 of the strip 12, as described above, in order to lock the at least one furniture moving component 504. A toddler, for example, is not expected to be able to open the at least one furniture moving component 504 that is locked with the locking system 1, and is also not expected to be able to unlock the locking system 1.

FIG. 20 schematically illustrates, according to an exemplary embodiment, a side perspective view of a locking system 1 locking at least one furniture moving component 504, while the strip 12 is folded and an anchoring element 127 of the strip 12 is anchored in a slot 124. According to one embodiment, in order to increase the security of the locking, and make it more difficult for a toddler, for example, to unlock the locking system 1, the strip 12 can be folded in a manner that an anchoring element 127 of the strip 12 is anchored in a slot 124 adjacent to the fastener 14 that is fastened to the strip 12 and locks the at least one furniture moving component 504. According to this embodiment, even if a toddler, for example, can release the fastening of the fastener 14 to the strip 12, he is not supposed to be able to slide the fastener 14 along the strip 12 because the anchoring element 127 that is anchored in a slot 124 adjacent to the fastener 14 blocks sliding of the fastener 14 along the strip 12 away from the at least one furniture moving component 504.

FIGS. 21A-D schematically illustrate, a front perspective view (FIG. 21A) and front views (FIG. 21B-D) of some exemplary embodiments of options for locking at least one furniture moving component 504 of a furniture 500 with a locking system 1. It should be mentioned that a furniture moving component 504 can be a door 5042 or a drawer 5044. FIG. 21A illustrates a locking system 1 locking two doors 5042. FIG. 21B illustrates a locking system 1 locking a door 5042 and three drawers 5044. FIG. 21C illustrates a locking system 1 locking two doors 5042 and two drawers 5044. FIG. 21D illustrates a locking system 1 locking two drawers 5044. The ability of the locking system 1 to lock at least one furniture moving component 504 relies on the shape and size of the clinging element 142 of the fastener 14, because this is the component that is in contact with the at least one furniture moving component 504 while locking it. Thus, a person skilled in the art would understand that the larger the clinging element 142, the larger is the amount of furniture moving components 504 that can be locked with the locking system 1.

According to one embodiment, the locking system 1 is configured to be attached, according to embodiments described above, to any location in a furniture.

To summarize, the locking system 1 is configured to lock at least one furniture moving component 504, the locking system 1 comprising a strip 12 configured to attach to a wall 504 of a furniture 500 and extend out of the furniture 500 beyond the at least one furniture moving component 504, and a fastener 14 configured to accommodate the strip 12, slide along the strip 12 and fasten to the strip 12 while clinging to the at least one furniture moving component 504, thereby locking the at least one furniture moving component 504.

According to one embodiment, the body 122 of the strip 12 is configured to extend out of the furniture 500 beyond the at least one furniture moving component.

The present subject matter further provides a method for locking at least one furniture moving component 504 of a furniture 500, the method comprising:
attaching a strip 12 to a wall 502 of the furniture 500 while letting a body 122 of the strip 12 to extend out of the furniture 500;
accommodating the strip 12 in a fastener 14;
closing the at least one furniture moving component 504;
sliding the fastener 14 along the strip 12 until the fastener 14 clings to the at least one furniture moving component 504; and
fastening the fastener 14 to the strip 12.
   Additional embodiments of the method for locking at least one furniture moving component 504 of a furniture 500 can be understood from the description of the locking system 1 herein.

As can be seen in the embodiment illustrated, for example, in FIGS. 12 and 12-A-B, the fastener teeth 1462 are adjacent to the clinging element 142 of the fastener 14, while the pressing elements 1464 are distant from the clinging element 142. In other words, when looking at a fastener 14 sliding over a strip 12, as illustrated, for example, in FIGS. 15 and 17, the fastening teeth 1462 are in a direction of the attaching element 126 of the strip 12, and the pressing elements 1464 are in an opposite direction relative to the attaching element 126 of the strip 12.

According to another embodiment, described in detail hereinafter, the orientation of the fastener teeth 1462 and the pressing elements 1464 is opposite to their orientation that was previously described.

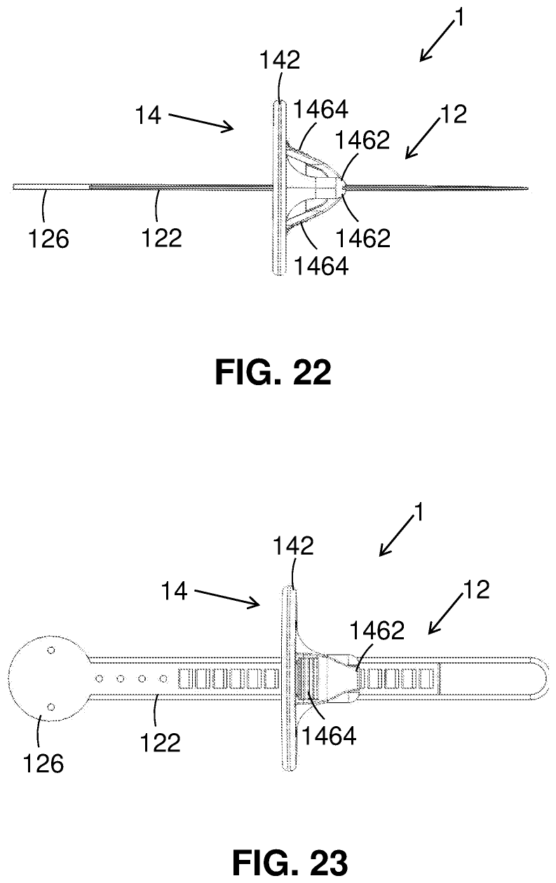

FIG. 22 schematically illustrates, according to an exemplary embodiment, a side view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 23 schematically illustrates, according to an exemplary embodiment, an upper view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

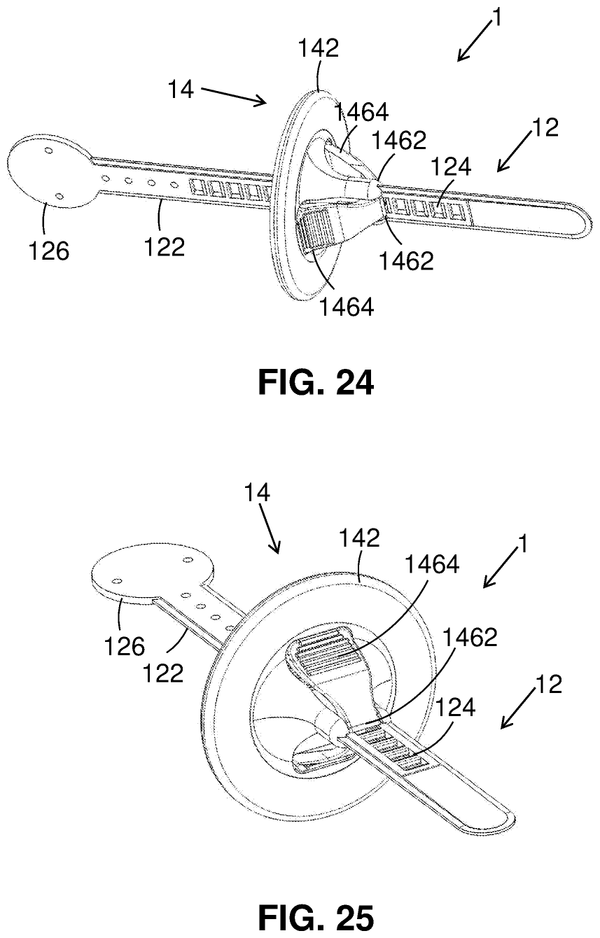

FIG. 24 schematically illustrates, according to an exemplary embodiment, an upper perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 25 schematically illustrates, according to an exemplary embodiment, a back perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

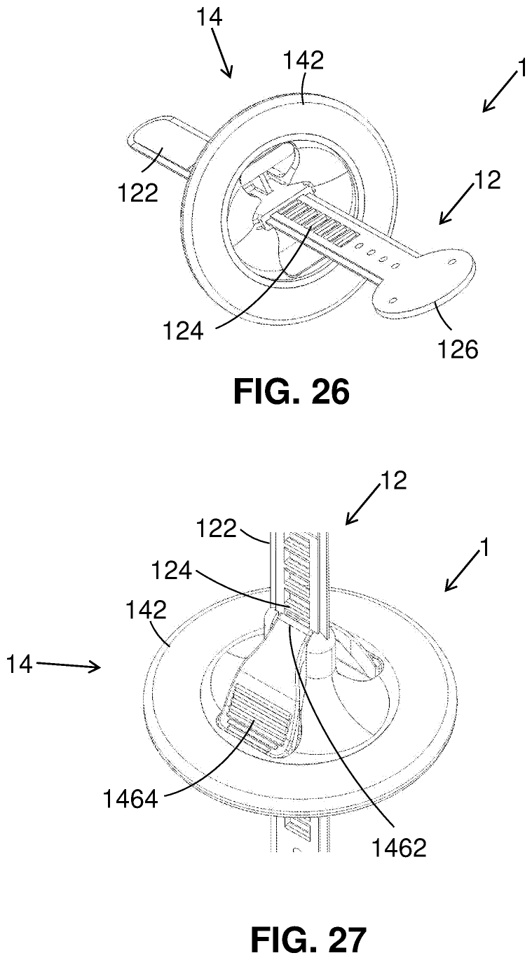

FIG. 26 schematically illustrates, according to an exemplary embodiment, a front perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 27 schematically illustrates, according to an exemplary embodiment, a close-up perspective view of a strip 12 accommodated in a fastener 14, when fastener teeth 1462 of the fastener 14 are distant from a clinging element 142 of the fastener 14 and pressing elements 1464 of the fastener 14 are adjacent to the clinging element 142 of the fastener 14.

According to the embodiment illustrated in FIGS. 22-27, the fastener teeth 1462 of the fastener 14 are distant from the clinging element 142 of the fastener 14 and pressing elements 1464 of the fastener 14 are adjacent to the clinging element 142 of the fastener 14. In other words, when looking at the fastener 14 sliding over the strip 12, the pressing elements 1464 are in a direction of the attaching element 126 of the strip 12, and the fastening teeth 1462 are in an opposite direction relative to the attaching element 126 of the strip 12.

The embodiment illustrated in FIGS. 22-27 is advantageous in term of resistance to an attempt to release a locked fastener 14 by pulling the fastener 14 away from the attaching element 126 and a furniture moving component 504 locked by the locking system 1. Pulling of the fastener 14 away from the attaching element 126 causes the fastener teeth 1462 to further be imbedded in the slot 124 of the strip 12 and resist a release of the locked fastener 14.

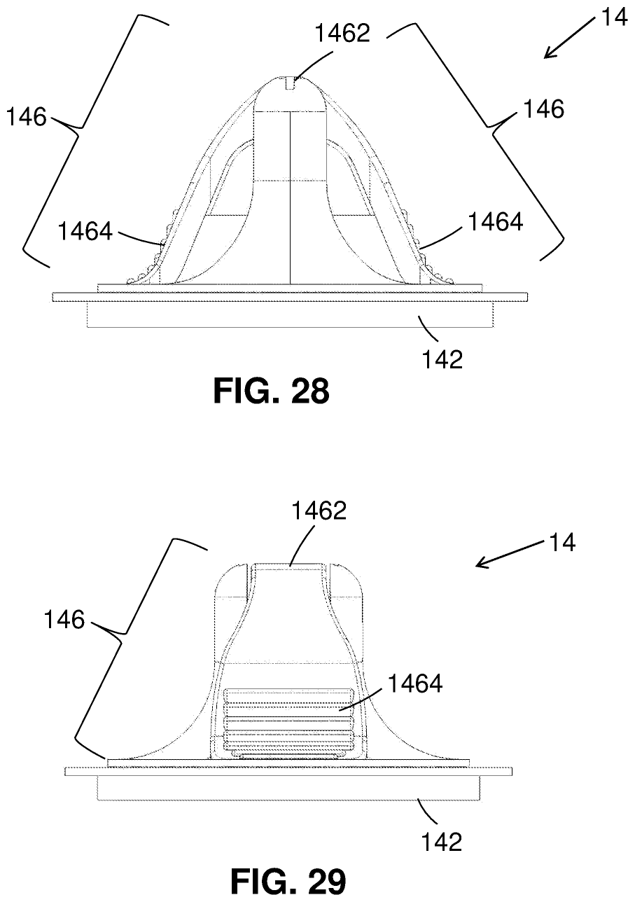

FIG. 28 schematically illustrates, according to an exemplary embodiment, a side view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 29 schematically illustrates, according to an exemplary embodiment, an upper view of a fastener 14, when fastener teeth 1462 of the fastener 14 are distant from a clinging element 142 of the fastener 14 and pressing elements 1464 of the fastener 14 are adjacent to the clinging element 142 of the fastener 14.

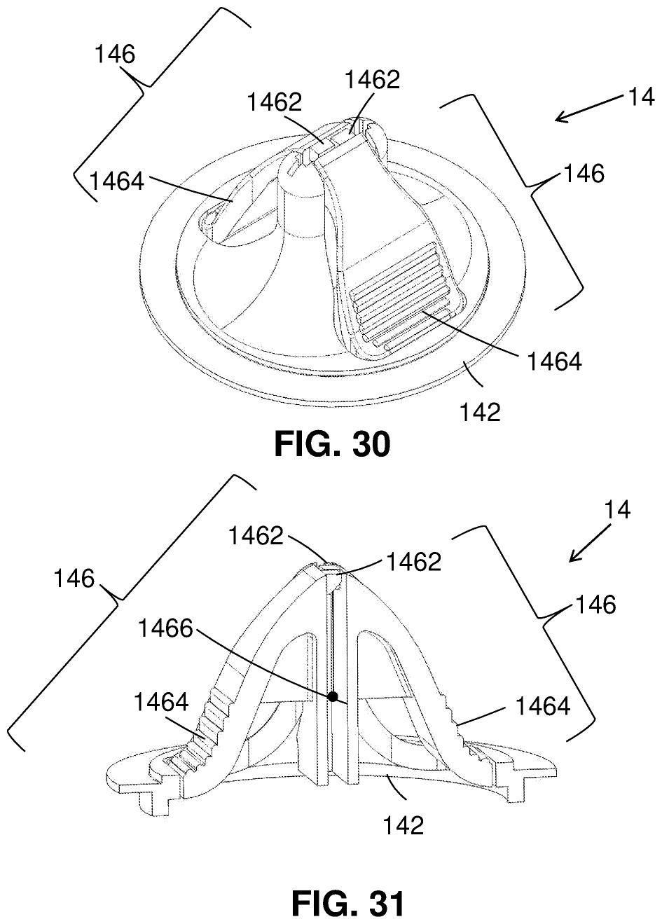

FIG. 30 schematically illustrates, according to an exemplary embodiment, an upper perspective view of a fastener 14, when fastener teeth 1462 of the fastener 14 are distant from a clinging element 142 of the fastener 14 and pressing elements 1464 of the fastener 14 are adjacent to the clinging element 142 of the fastener 14.

As described above, the fastener pressing elements 1464 and the fastener teeth 1462, are both comprised in a strip engaging element 146 of the fastener 14, as marked in FIG. 28. As further described above, the strip engaging element 146 can be either in a closed state, when the fastener teeth 1462 are close to each other, or in an open state, when the fastener teeth 1462 are apart one from the other. According to one embodiment, the closed state is a default state of the strip engaging element 146. In the embodiment illustrated in FIGS. 28-30, the strip engaging element 146 is in a closed state, that in some embodiments can be a default state.

In order to bring the strip engaging element 146 to an open state, the pressing elements 1464 are pressed one towards the other. As a result, the fastener teeth 1462 are forced to move apart, namely move away one from the other. This can be achieved, for example, by defining an axis of the strip engaging element 146, as will be described hereinafter.

FIG. 31 schematically illustrates, according to an exemplary embodiment, a perspective side cross-section view of a fastener 14, when fastener teeth 1462 of the fastener 14 are distant from a clinging element 142 of the fastener 14 and pressing elements 1464 of the fastener 14 are adjacent to the clinging element 142 of the fastener 14.

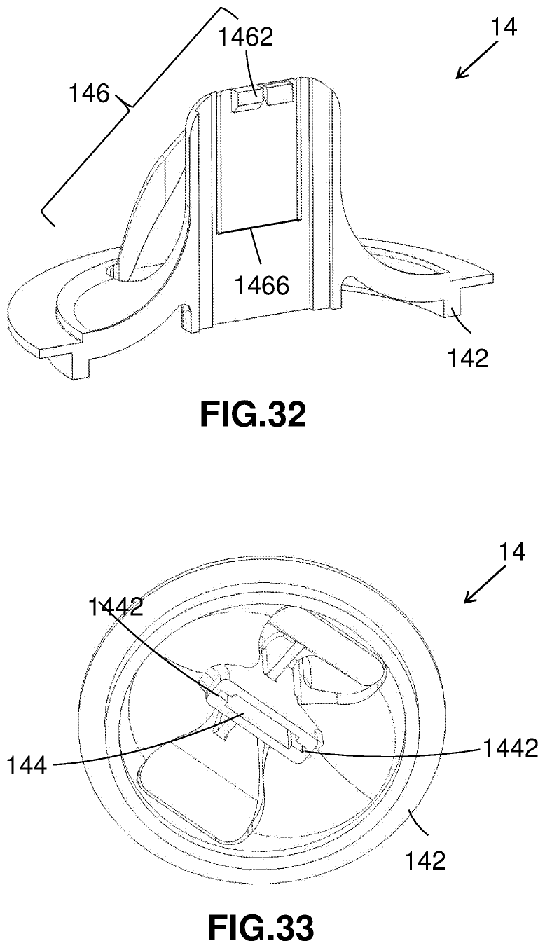

FIG. 32 schematically illustrates, according to an exemplary embodiment, a perspective front cross-section view of a fastener 14, when fastener teeth 1462 of the fastener 14 are distant from a clinging element 142 of the fastener 14 and pressing elements 1464 of the fastener 14 are adjacent to the clinging element 142 of the fastener 14.

As can be seen in FIG. 31-32, an axis 1466 is defined between the fastener teeth 1462 and the pressing elements 1464. When the pressing elements 1464 are pressed, the strip engaging element 146 bends at the axis 1466 and as a result the fastener teeth 1462 move away one from the other, thus bringing the strip engaging element 146 from a closed state to an open state. In other words, the axis 1466 serves as a bending point of the strip engaging element 146.

According to some embodiments, the fastener 14 can be manufactured by assembling separate parts together. For example, the fastener 14 can comprise a strip engaging element 146 that is assembled with a clinging element 142 that is manufactured separately, or even the strip engaging element 146 can comprise a first piece comprising a first fastener tooth 1462 and a first pressing element 1464 assembled with a second piece comprising a second fastener tooth 1462 and a second pressing element 1464, with a pivot 1466 defined in-between (not shown). According to another embodiment, the entire fastener 14 is made of one piece of material. The fastener 14 illustrated, for example, in FIGS. 31-32 is made of one piece of material.

The present subject matter provides a method for manufacturing the fastener 14, the method comprising:
preparing a mold of the fastener 14 according to embodiments described herein; and
inserting a casting material into the mold.
   According to one embodiment, the casting material is plastic. It should be noted that a person skilled in the art would be able to manufacture the fastener as described above, based on the description herein and the accompanying drawings.

In an embodiment of a fastener 14 manufactured in one piece, when pressing the pressing elements 1464, the shape of the strip engaging element 146 can be distorted in an uncontrolled manner instead of bending at the axis 1466. In this situation, pressing of the pressing elements 1464 will not cause the fastener teeth 1462 to move away one from the other. In order to prevent this situation, the fastener 14 further comprises two strengthening ribs 1468, that can be clearly seen in FIG. 31. The strengthening ribs 1468 are positioned at a bottom of the strip engaging element 146 just above the axis. This prevents uncontrolled distortion of the strip engaging element 146 and forces the strip engaging element 146 to bend at the axis 1466 when the pressing elements are pressed.

FIG. 33 schematically illustrates, according to an exemplary embodiment, a bottom perspective view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 33 illustrates, inter alia, a bottom view of an opening 144 of the fastener 14. The opening is configured to accommodate the body 122 of the strip 12, thus enabling sliding of the fastener 14 along the body 122 of the strip 12. According to some embodiments, the opening 144 can further comprise a side channel 1442 at each side of the opening 144 that is configured to facilitate sliding of the fastener 14 along the body 122 of the strip 12 that is accommodated in the opening 144.

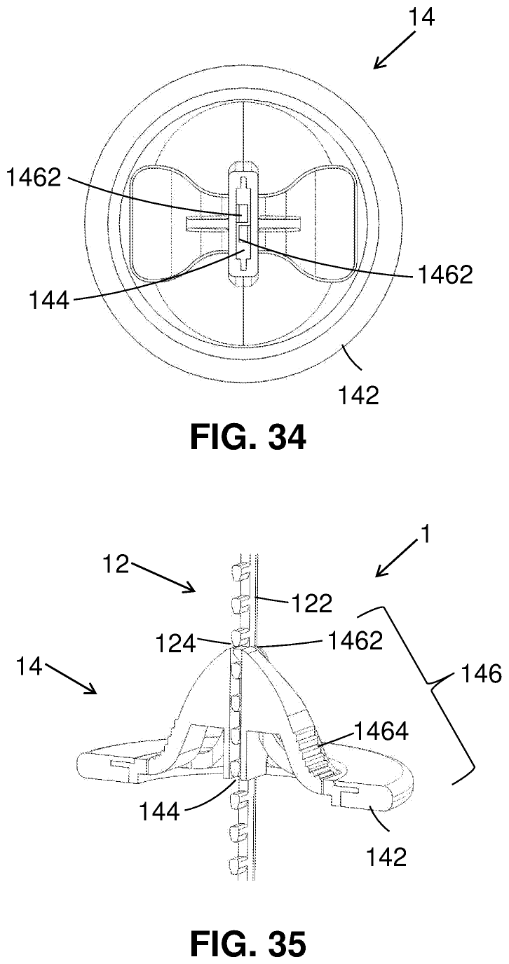

FIG. 34 schematically illustrates, according to an exemplary embodiment, an upper view of a fastener 14, when fastener teeth 1462 of the fastener 14 are distant from a clinging element 142 of the fastener 14 and pressing elements 1464 of the fastener 14 are adjacent to the clinging element 142 of the fastener 14.

FIG. 34 illustrates, inter alia, an upper view of the opening 144 of the fastener 14. The fastener teeth 1462 are also seen inside the opening 144, when the strip engaging element 146 is in a closed state. According to one embodiment, the fastener teeth 1462 reside one adjacent to the other in an upper part of the opening 144.

FIG. 35 schematically illustrates, according to an exemplary embodiment, a perspective side cross-section view of a body 122 of a strip 12 accommodated in an opening 144 of a fastener 14, when fastener teeth 1462 of the fastener 14 are distant from a clinging element 142 of the fastener 14 and pressing elements 1464 of the fastener 14 are adjacent to the clinging element 142 of the fastener 14.

The strip engaging element 146 of the fastener 14 illustrated in FIG. 35 is in a closed state. Thus, the fastener teeth 1462 are adjacent one to the other and are essentially locked inside a slot 124 of the body 122 of the strip 12. Pressing of the pressing elements 1464 causes the fastener teeth 1462 to move away one from the other and thus release the locking of the fastener 14 and allow sliding of the fastener 14 along the body 122 of the strip.

It is appreciated that certain features of the subject matter, which are, for clarity, described in the context of separate embodiments, can also be provided in combination in a single embodiment. Conversely, various features of the subject matter, which are, for brevity, described in the context of a single embodiment, can also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A locking system configured to lock at least one furniture moving component, the locking system comprising:
a strip configured to attach to a wall of a furniture and extend out of the furniture beyond the at least one furniture moving component; and
a fastener configured to accommodate the strip, slide along the strip and fasten to the strip while clinging to the at least one furniture moving component, thereby locking the at least one furniture moving component.

2. The locking system of claim 1, wherein the strip comprises a body comprising a plurality of slots, wherein the body is configured to extend out of the furniture beyond the at least one furniture moving component.

3. The locking system of claim 1, wherein the strip comprises an attaching element configured to attached to the wall of the furniture.

4. The locking system of claim 1, wherein the fastener comprises a clinging element configured to cling to the at least one furniture moving component.

5. The locking system of claim 4, wherein the clinging element comprises an opening configured to accommodate the strip or the body of the strip.

6. The locking system of claim 1, wherein the fastener comprises a strip engaging element configured to engage with the strip or with a slot of the strip.

7. The locking system of 6, wherein the strip engaging element can be either in a locked state or an open state, wherein in the locked state the strip engaging element is configured to engage with the strip or with a slot of the strip, while in the open state, the strip engaging element is configured not to engage with the strip or with a slot of the strip.

8. The locking system of claim 7, wherein the locked state is a default state.

9. The locking system of claim 6, wherein the strip engaging element comprises two fastener teeth, each attached to a pressing element, wherein the fastener teeth are configured to engage with the strip or with a slot of the strip, and the pressing elements are configured to be pressed, thereby removing the fastener teeth from the strip or a slot of the strip.

10. The locking system of claim 9, wherein the fastener teeth are adjacent to the clinging element, and the pressing elements are distant from the clinging element.

11. The locking system of claim 9, wherein the pressing elements are adjacent to the clinging element, and the fastener teeth are distant from the clinging element.

12. The locking system of claim 1, wherein the fastener is made of one piece of material.

13. A method for manufacturing the fastener of claim 12, the method comprising:
preparing a mold of the fastener; and
inserting a casting material into the mold.

14. The method of claim 13, wherein the casting material is plastic.

15. A method for locking at least one furniture moving component of a furniture, the method comprising:
attaching a strip to a wall of the furniture while letting a body of the strip to extend out of the furniture;
accommodating the strip in a fastener;
closing the at least one furniture moving component;
sliding the fastener along the strip until the fastener clings to the at least one furniture moving component; and
fastening the fastener to the strip.
